(19) United States
(12) Patent Application Publication
(10) Pub. No.: US 2014/0354604 A1
(43) Pub. Date: Dec. 4, 2014

(54) WATERPROOF STYLUS

(71) Applicant: Hui-Hu Liang, Changhua County (TW)

(72) Inventor: Chi-Tsung HUANG, Sioushuei Township (TW)

(73) Assignee: Hui-Hu LIANG, Changhua County (TW)

(21) Appl. No.: 14/161,674

(22) Filed: Jan. 22, 2014

(30) Foreign Application Priority Data
May 31, 2013 (CN) 201320308574.6

(51) Int. Cl. G06F 3/0354; B43K 23/08

(52) U.S. Cl. CPC G06F 3/03545; B43K 23/08
USPC 345/179

(57) ABSTRACT

A waterproof stylus is provided. The waterproof stylus comprises a hollow pen body. A circuit board is formed within the hollow pen body and has at least one switch. The hollow pen body has an opening, and a button is formed at the opening. The button abuts the switch of the circuit board so that when the button is subjected to pressure, the switch of the circuit board is synchronously triggered. Thereby the circuit board generates an electrical signal to the touch panel, which the waterproof stylus cooperates with. There is a waterproof member formed between the hollow pen body and the button, and the waterproof member seals the opening of the hollow pen body to block external water and air from getting into the hollow pen body and damaging the control unit. Therefore, the stylus of the present invention provides a good waterproofing effect.

### BACKGROUND OF THE INVENTION

1. Field of the Invention

The present invention is related to the stylus used with touch panels, especially related to a waterproof stylus.

2. Description of Related Art

Touch panels have become widely used in various electronic devices, such as personal digital assistants, smart phones, or tablets. Users only need to use their fingers to press or swipe on the touch panel, and operating instructions are then input into the electronic device. Due to the large contact area between the finger and the touch panel, the touch panel sometimes will incorrectly sense the user's operation and the electronic device may perform unexpected wrong results. Therefore, in addition to operating with finger touching, users may also choose to use a stylus to point and touch so that the operation of the touch panel can be more precise.

The conventional stylus mostly focuses on the functions of use and operation. For example, some styluses are installed with a button on the body of the stylus, which can be controlled to transmit electrical signals to the touch panel for operation by pressing the button. However, the conventional stylus does not provide any waterproof protection for the button. This kind of design can result in external water and air easily getting into the stylus through the gap around the button, and thereby causing damage to the electronic components inside the stylus. Therefore, the conventional structure of the stylus does indeed need to be improved.

### SUMMARY OF THE INVENTION

The objective of the present invention is to provide a stylus, which provides a good waterproof effect.

To achieve the above objective, the stylus pen of the present invention comprises a hollow pen body, a control unit, and a waterproof member. The hollow pen body has an opening. The control unit has a circuit board and a button. The circuit board is formed within the hollow pen body and has a switch. The button is formed at the hollow pen body, abuts the switch of the circuit board and corresponds to the opening the hollow pen body. When the button is subjected to pressure, the switch is triggered and the circuit board generates an electrical signal. The waterproof member is formed between the hollow pen body and the button of the control unit, and seals the opening of the hollow pen body to provide the waterproofing effect.

In an embodiment of the present invention, a peripheral edge of the opening of the hollow pen body is formed with a stepped portion, and the waterproof member is plate-shaped and is fixed to the stepped portion.

In an embodiment of the present invention, the waterproof member is plate-shaped and has an embedding slot, and the embedding slot of the waterproof member is connected to a peripheral edge of the opening of the hollow pen body.

In an embodiment of the present invention, an outer surface of the hollow pen body has a ring groove connecting to the opening, and the waterproof member is ring-shaped, is circularly formed on the hollow pen body, and is fixed in the ring groove.

In an embodiment of the present invention, a peripheral edge of the opening of the hollow pen body is formed with a stepped portion, and the waterproof member is integrally connected to an outer peripheral edge of the button and is fixed to the stepped portion.

In an embodiment of the present invention, a peripheral edge of the opening of the hollow pen body is formed with an embedding portion, the waterproof member is plate-shaped and has an embedding slot, and the embedding slot of the waterproof member is connected to the embedding portion of the hollow pen body.

In an embodiment of the present invention, a peripheral edge of the opening of the hollow pen body is formed with a projecting portion, the waterproof member is integrally connected to an outer peripheral edge of the button and has a recessed portion, and the recessed portion of the waterproof member and the projecting portion of the hollow pen body are engaged with each other.

In an embodiment of the present invention, a peripheral edge of the opening of the hollow pen body is formed with two projecting portions spaced apart from each other, the waterproof member is integrally connected to an outer peripheral edge of the button and has a projecting portion, and the projecting portion of the waterproof member is engaged between the two projecting portions of the hollow pen body.

In an embodiment of the present invention, a peripheral edge of the opening of the hollow pen body is formed with a recessed portion, the waterproof member is integrally connected to an outer peripheral edge of the button and has a projecting portion, and the projecting portion of the waterproof member and the recessed portion of the hollow pen body are engaged with each other. A pressing plate is formed in the hollow pen body, and the pressing plate presses against the waterproof member to maintain the connection between the waterproof member and the hollow pen body.

### BRIEF DESCRIPTION OF THE DRAWINGS

FIG. 1 is a perspective view of a first embodiment of the present invention.

FIG. 2A is a partial cross-sectional view of the first embodiment of the present invention.

FIG. 2B is a partial cross-sectional view of a second embodiment of the present invention.

FIGS. 3A to 3D are partial cross-sectional views of a. third embodiment of the present invention.

FIG. 4 is a perspective view of a fourth embodiment of the present invention.

FIG. 5 is a partial cross-sectional view of the fourth embodiment of the present invention.

FIGS. 6A to 6B are partial cross-sectional views of a fifth embodiment of the present invention.

FIGS. 7A to 7D are partial cross-sectional views of a sixth embodiment of the present invention.

FIG. 8 is a partial cross-sectional view of a seventh embodiment of the present invention.

FIG. 9 is a partial cross-sectional view of an eighth embodiment of the present invention.

FIG. 10 is a partial cross-sectional view of a ninth embodiment of the present invention.

FIG. 11 is a partial cross-sectional view of a tenth embodiment of the present

### DESCRIPTION OF THE PREFERRED EMBODIMENT

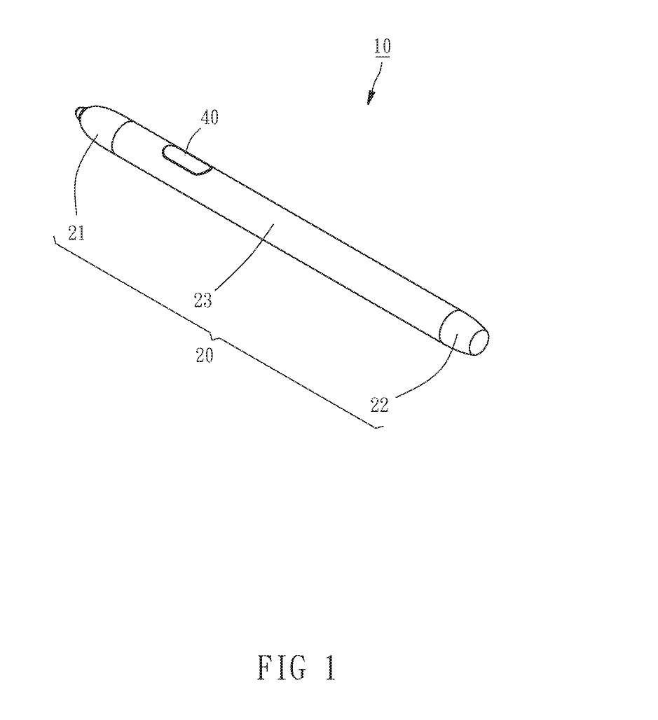

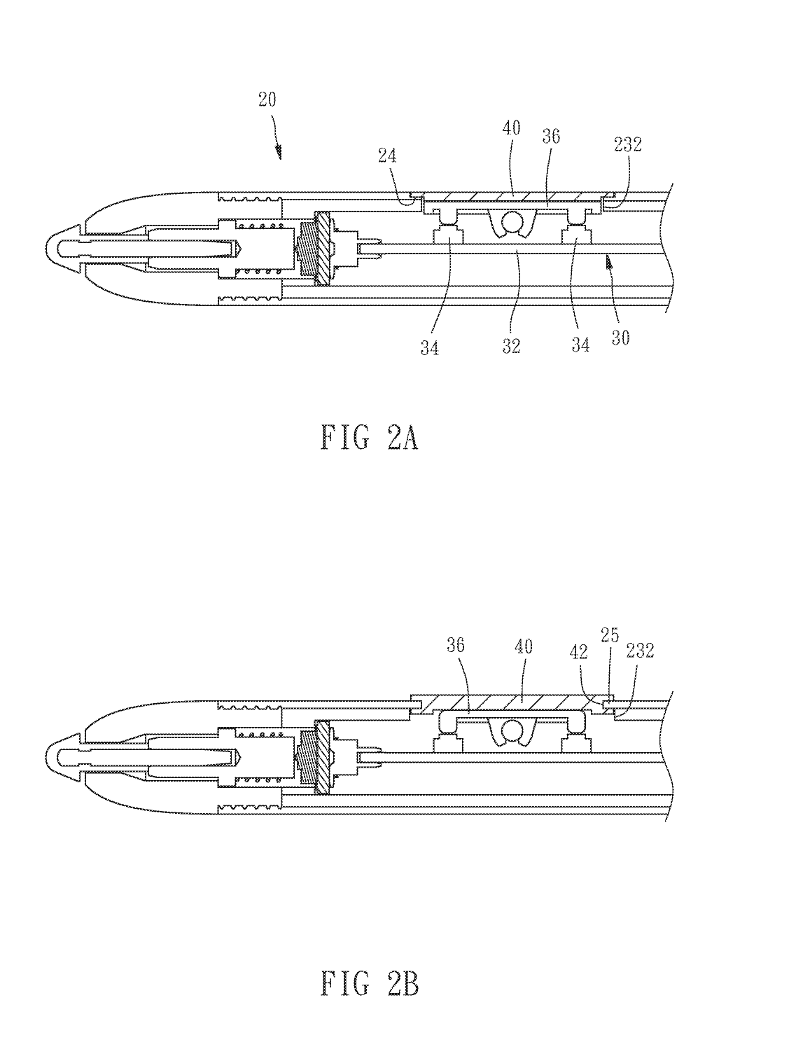

Refer to FIG. 1 and FIG. 2, which show the stylus 10, comprising a hollow pen body 20, a control unit 30 and a waterproof member 40, of the present invention.

The hollow pen body 20 has a head portion 21, a tail portion 22, and a body portion 23 disposed between the head portion 21 and the tail portion 22. A position of the body portion 23 close to the head portion 21 is formed with an opening 232.

The control unit 30 has a circuit board 32 and a button 36. The circuit board 32 is fixed in the body portion 23 of the hollow pen body 20 and has two switches 34, which are spaced apart from each other. The button 36 is connected to the body portion 23 of the hollow pen body 20 and abuts the two switches 34 of the circuit board 32. The position of the button 36 corresponds to the opening 232 of the hollow pen body 20 for the user to press to trigger the two switches 34 so that the circuit board 32 generates an electrical signal. Furthermore, the control unit 30 further has a nib 38 which is electrically connected to the circuit board 32 and extends out of the head portion 21 of the hollow pen body 20. The nib 38 is used for pointing and touching the touch panel of the electronic device (not shown) for electrical signal transmission.

The waterproof member 40 can be made of rubber, silicone, plastic or other waterproof materials. The waterproof member 40 is installed between the body portion 23 of the hollow pen body 20 and the button 36 of the control unit 30, and the waterproof member 40 seals the opening 232. In the embodiments of the present invention, the waterproof member 40, the hollow pen body 20 and the button 36 have a variety of different combinations, as follows:

As shown in FIG. 2A, a peripheral edge of the opening 232 of the hollow pen body 20 is formed with a stepped portion 24. The waterproof member 40 is plate-shaped and is fixed to the stepped portion 24 by hot melt adhesion or gluing. After being fixed to the stepped portion, the waterproof member 40 is adhered to and abuts an outer surface of the button 36.

As shown in FIG. 2B, a peripheral edge of the opening 232 of the hollow pen body 20 is formed with an embedding portion 25. The waterproof member 40 is plate-shaped and has an embedding slot 42 for the embedding portion 25 of the hollow pen body 20 to engage to. Hot melt adhesion or gluing can be adopted at the same time to increase the bonding strength between the two portions. The waterproof member 40 is adhered to and abuts an outer surface of the button 36 after being fixed.

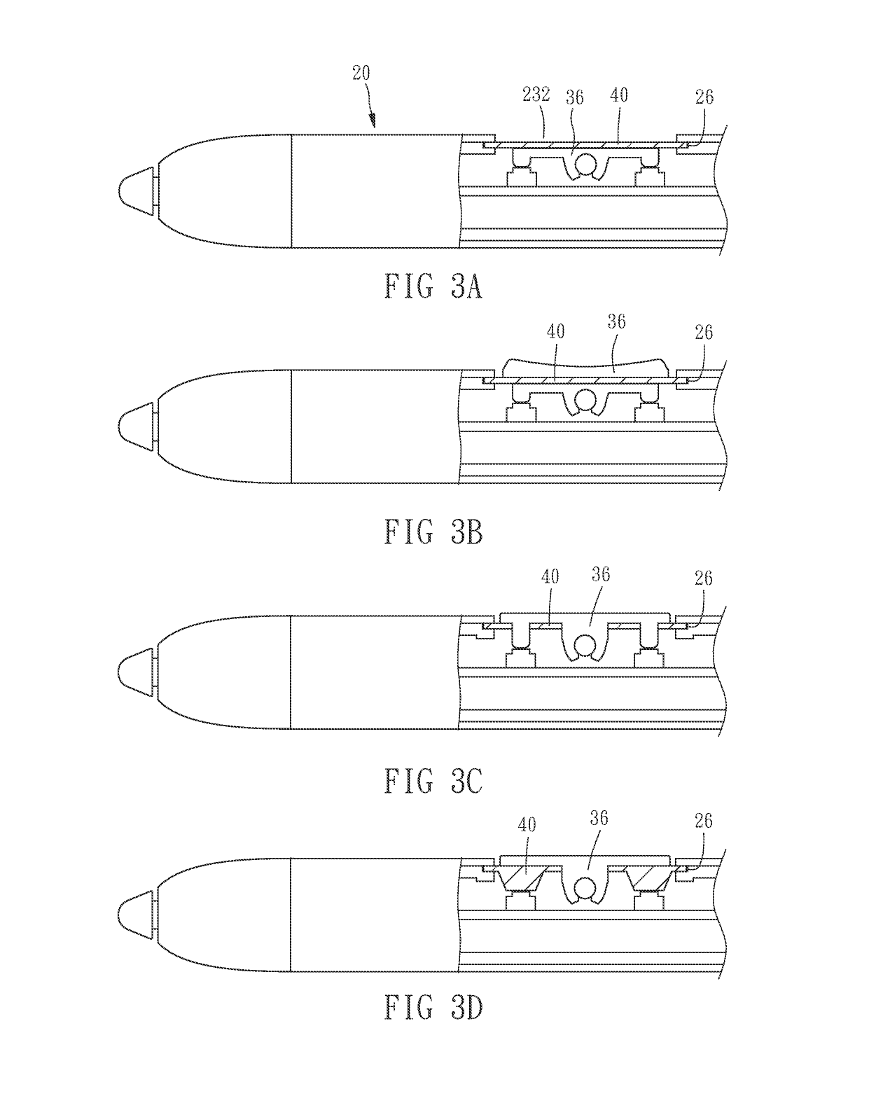

As shown in FIG. 3A, a peripheral edge of the opening 232 of the hollow pen body 20 has a wedge slot 26 for an outer peripheral edge of the plate-shaped waterproof member 40 to embed in. Hot melt adhesion or gluing can be adopted at the same time to increase the bonding strength between the two portions. The waterproof member 40 is adhered to and abuts an outer surface of the button 36 after being fixed. Moreover, as shown in FIGS. 3B to 3D, it is not necessary for the waterproof member 40 to be adhered to and abut the outer surface of the button 36, but is designed as ring-shaped and is circularly formed on the button 36 and then embedded in the wedge slot 26 of the hollow pen body 20.

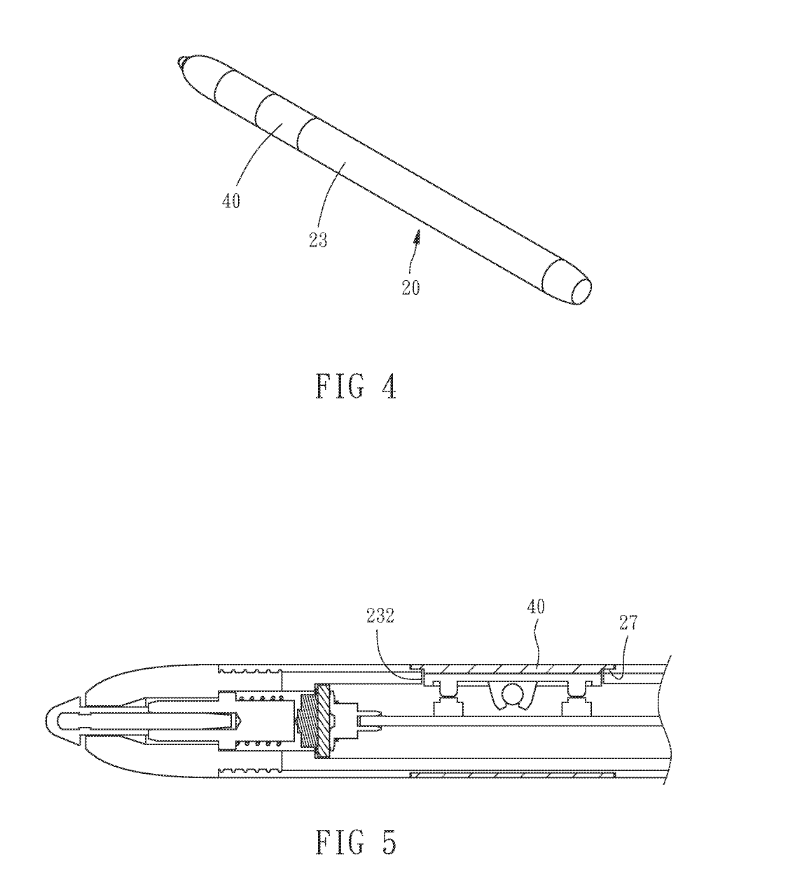

As further shown FIG. 4 and FIG. 5, the ring-shaped waterproof member 40 is not necessarily circularly formed on the button 36, but directly circularly formed in a ring groove 27 of the body portion 23 of the hollow pen body 20. The ring groove 27 and the opening 232 connect with each other, and hot melt adhesion or gluing can be adopted at the same time to increase the bonding strength between the two portions.

Though the waterproof member 40 and the button 36 referenced above are a two-piece structure, in actuality, the waterproof member 40 and the button 36 can be an integrally formed structure.

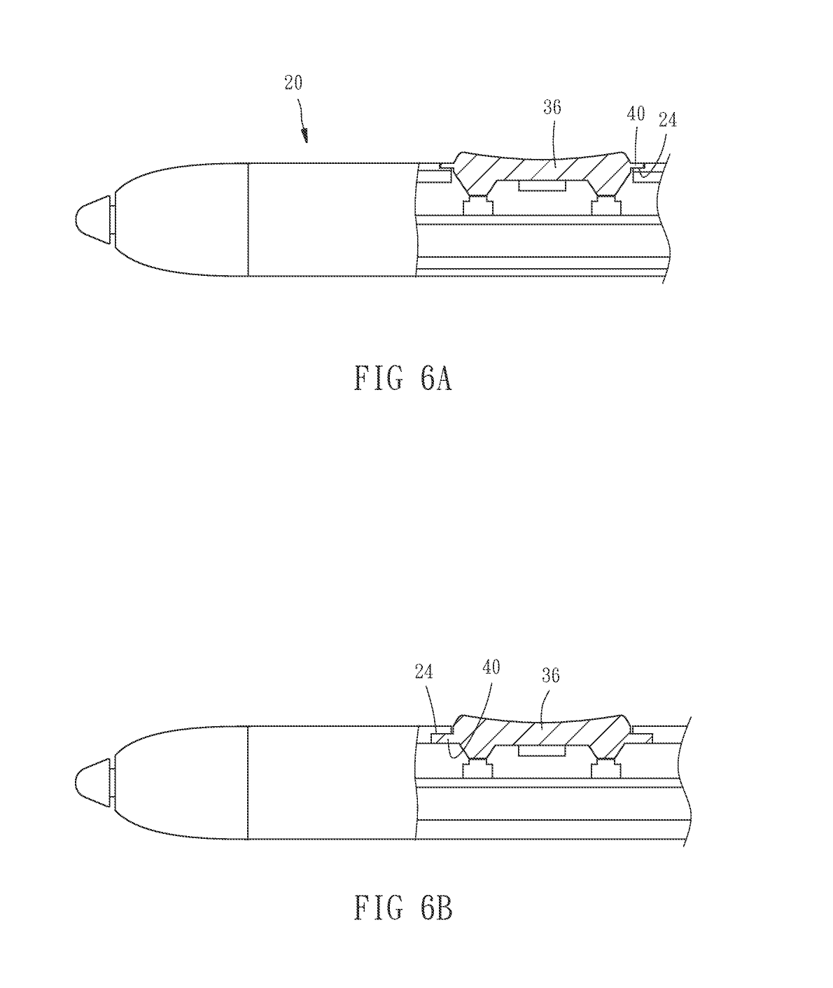

As shown in FIGS. 6A and 6B, the waterproof member 40 is integrally connected to an outer peripheral edge of the button 36 and is connected to the stepped portion 24 of the hollow pen body 20 by the hot melt adhesion or gluing. The stepped portion 24 can be disposed on an outer surface or an inner surface of the hollow pen body 20.

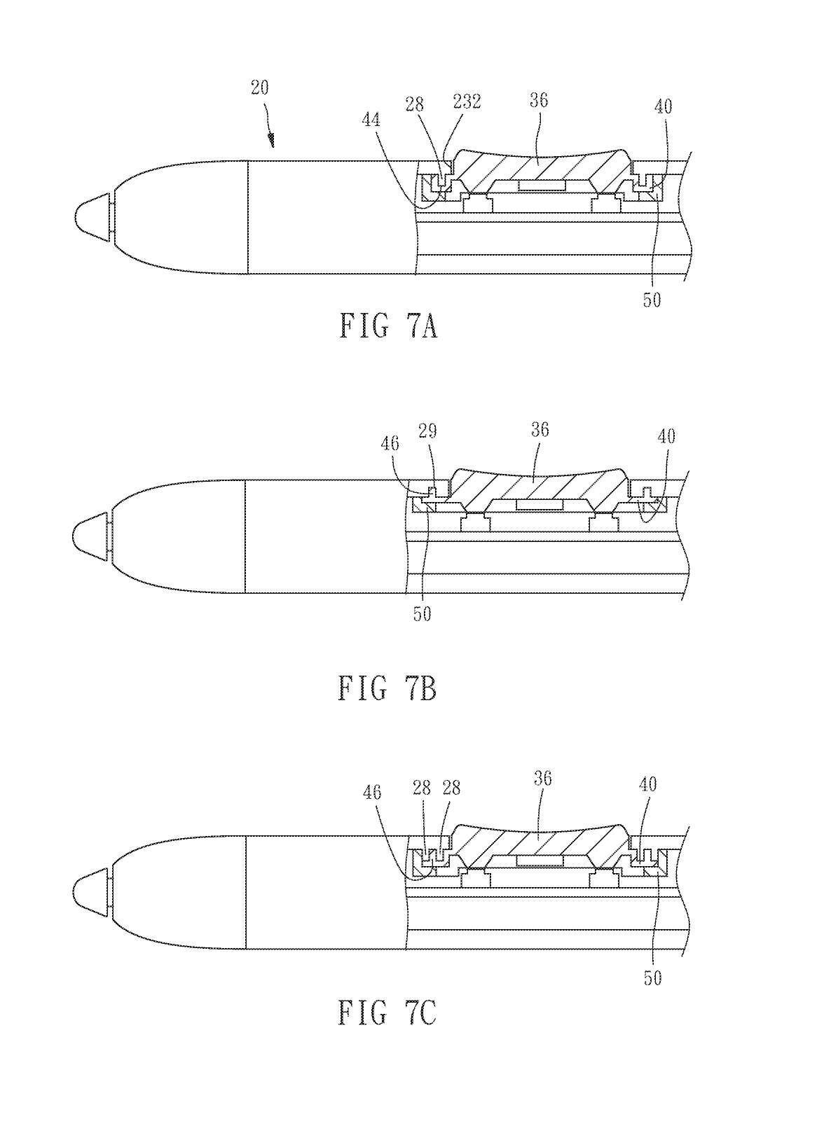

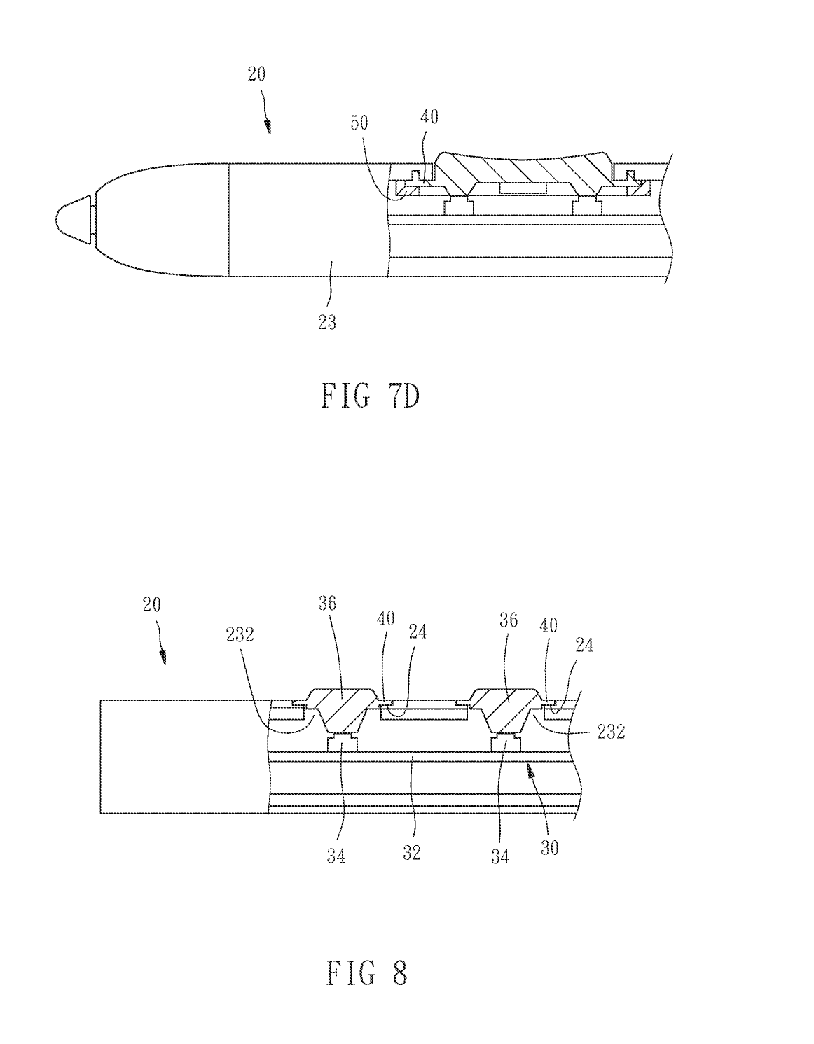

On the other hand, in addition to being fixed by hot melt adhesion or gluing, the waterproof member 40 and the hollow pen body 20 can be also further fixed by way of engagement. As shown in FIG. 7A, a peripheral edge of the opening 232 of the hollow pen body 20 is formed with a projecting portion 28. The waterproof member 40 is integrally connected to an outer peripheral edge of the button 36 and has a recessed portion 44 for the projecting portion 28 of the hollow pen body 20 to engage with. Or, as shown in FIG. 7B, a peripheral edge of the opening 232 of the hollow pen body 20 is formed with a recessed portion 29. The waterproof member 40 is integrally connected to an outer peripheral edge of the button 36 and has a projecting portion 46 for the recessed portion 29 of the hollow pen body 20 to engage with. Or, as shown in FIG. 7C, a peripheral edge of the opening 232 of the hollow pen body 20 is formed with two projecting portions 28 spaced apart from each other. The waterproof member 40 is integrally connected to an outer peripheral edge of the button 36 and has a projecting portion 46, engaged between the two projecting portions 28 of the hollow pen body 20. Furthermore, after the waterproof member 40 and the hollow pen body 20 are fixed by engaging with each other, an inner surface of the body portion 23 of the hollow pen body 20 can be further formed with a pressing plate 50, as shown in FIGS. 7A to 7D, to press against the waterproof member 40 to maintain a secure engagement effect between the waterproof member 40 and the hollow pen body 20.

As further shown in FIG. 8, the control unit 30 can be formed with two independent buttons 36 to correspond to the two switches 34 of the circuit board 32. An outer peripheral edge of each of the buttons 36 is integrally connected with a waterproof member 40. Each of the waterproof members 40 are fixed to the stepped portion 24 of the hollow pen body 20 by the hot melt adhesion or gluing to seal the opening 232 of the hollow pen body 20.

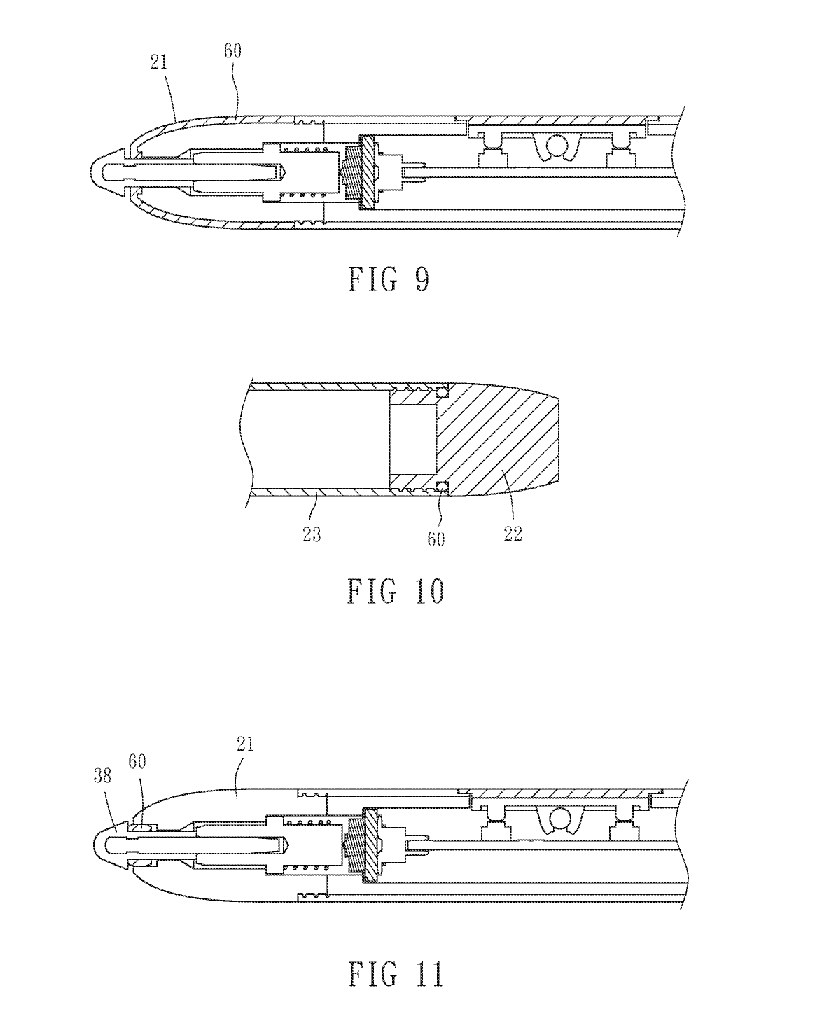

Finally, it should be supplementally illustrated that in addition to the waterproof member 40, the stylus 10 of the present invention can further provide a waterproof ring 60 as a second protective layer of waterproofing. The waterproof ring 60 can be mounted at different positions according to actual conditions. For example, it can be directly fixed at the head portion 21 of the hollow pen body 20 (as shown in FIG. 9), fixed between the body portion 23 and the tail portion 22 of the hollow pen body 20 (as shown on FIG. 10), or mounted between the head portion 21 of the hollow pen body 20 and the nib 38 of the control unit 30 (as shown in FIG. 11). Thereby, the waterproof function of the stylus 10 of the present invention can be more perfect.

In summary, with different structure designs of the waterproof member 40 of the present invention stylus 10, external water and air can be blocked from getting inside of the hollow pen body 20 so that the control unit 30 or other electronic components can be prevented from being damaged, elongating the lifetime of the stylus.

What is claimed is:

1. A waterproof stylus, comprising:
a hollow pen body having an opening;
a control unit having a circuit board and a button, the circuit board being formed within the hollow pen body and having a switch, the button being formed at the hollow pen body, abutting the switch of the circuit board and corresponding to the opening the hollow pen body; and
a waterproof member being formed between the hollow pen body and the button of the control unit and sealing the opening of the hollow pen body.

2. The waterproof stylus as claimed in claim 1, wherein a peripheral edge of the opening of the hollow pen body is formed with a stepped portion, and the waterproof member is plate-shaped and is fixed to the stepped portion.

3. The waterproof stylus as claimed in claim 1, wherein a peripheral edge of the opening of the hollow pen body is formed with an embedding portion, the waterproof member has an embedding slot, and the embedding slot of the waterproof member is connected to the embedding portion of the hollow pen body.

4. The waterproof stylus as claimed in claim 1, wherein an outer surface of the hollow pen body has a ring groove connecting to the opening, and the waterproof member is ring-shaped and is circularly formed in the ring groove of the hollow pen body.

5. The waterproof stylus as claimed in claim 1, wherein a peripheral edge of the opening of the hollow pen body is formed with a stepped portion, and the waterproof member is integrally connected to an outer peripheral edge of the button and is fixed to the stepped portion.

6. The waterproof stylus as claimed in claim 1, wherein a peripheral edge of the opening of the hollow pen body is formed with a wedge slot, and an outer peripheral edge of the waterproof member is embedded in the wedge slot.

7. The waterproof stylus as claimed in claim 1, wherein a peripheral edge of the opening of the hollow pen body is formed with a projecting portion, the waterproof member is integrally connected to an outer peripheral edge of the button and has a recessed portion, and the recessed portion of the waterproof member and the projecting portion of the hollow pen body are engaged with each other.

8. The waterproof stylus as claimed in claim 1, wherein peripheral edge of the opening of the hollow pen body is formed with a recessed portion, the waterproof member is integrally connected to an outer peripheral edge of the button and has a projecting portion, and the projecting portion of the waterproof member and the recessed portion of the hollow pen body are engaged with each other.

9. The waterproof stylus as claimed in claim 1, wherein a peripheral edge of the opening of the hollow pen body is formed with two projecting portions spaced apart from each other, the waterproof member is integrally connected to an outer peripheral edge of the button and has a projecting portion, and the projecting portion of the waterproof member is engaged between the two projecting portions of the hollow pen body.

10. The waterproof stylus as claimed in claim 7, wherein a pressing plate is formed in the hollow pen body, and the pressing plate presses against the waterproof member.

11. The waterproof stylus as claimed in claim 8, wherein a pressing plate is formed in the hollow pen body, and the pressing plate presses against the waterproof member.

12. The waterproof stylus as claimed in claim 9, wherein a pressing plate is formed in the hollow pen body, and the pressing plate presses against the waterproof member.

13. The waterproof stylus as claimed in claim 1, wherein the hollow pen body has a head portion, the control means has a nib, disposed at the head portion of the hollow pen body, and a waterproof ring is formed between the head portion of the hollow pen body and the nib.

14. The waterproof stylus as claimed in claim 1, wherein the hollow pen body has a body portion and a tail portion, and a waterproof ring is formed between the body portion and the tail portion.

15. The waterproof stylus as claimed in claim 1, wherein the hollow pen body has a head portion, the head portion is formed with a waterproof ring, and the waterproof ring is partially combined with the head portion.
